(19) United States
(12) Patent Application Publication
(10) Pub. No.: US 2011/0012903 A1
(43) Pub. Date: Jan. 20, 2011

(54) SYSTEM AND METHOD FOR REAL-TIME CHARACTER ANIMATION

(76) Inventor: Michael Girard, Palo Alto, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/504,532

(22) Filed: Jul. 16, 2009

(51) Int. Cl. G06T 15/70

(52) U.S. Cl. 345/474

(57) ABSTRACT

A method for generating a motion sequence of a character object in a rendering application. The method includes selecting a first motion clip associated with a first motion class and selecting a second motion clip associated with a second motion class, where the first and second motion clips are stored in a memory. The method further includes generating a registration curve that temporally and spatially aligns one or more frames of the first motion clip with one or more frames of the second motion clip, and rendering the motion sequence of the character object by blending the one or more frames of the first motion clip with one or more frames of second motion clip based on the registration curve. One advantage of techniques described herein is that they provide for creating motion sequences having multiple motion types while minimizing or even eliminating motion artifacts at the transition points.

### BACKGROUND OF THE INVENTION

1. Field of the Invention

The present invention generally relates to computer software. More specifically, the present invention relates to a system and method for real-time character animation.

2. Description of the Related Art

The term “rendering application” refers to a broad variety of computer-based tools used by architects, engineers, animators, video game designers, and other graphics and design professionals. Rendering is the process of generating an image from a model by means of computer programs and/or specified hardware.

A desired feature of rendering applications is the ability to generate frames of an animation sequence in real-time using one or more motion clips. Typically, motion clips are created using a motion capture system, where a human motion capture actor wears markers near each joint to identify a motion by positions or angles between the markers. The markers are tracked to sub-millimeter positions. Motion capture computer software records the positions, angles, velocities, accelerations, and impulses of the markers, providing an accurate digital representation of the actor's motion. The digital representation is then used to generate a motion clip.

In the video game industry, many game products include goal-driven characters that are not controlled directly by the player of the game. These characters are called “non-player characters” or “NPCs.” The most popular games (sports, role-playing, strategy, and first person shooters) make heavy use of NPCs to provide the key action elements in the game. For example, in a football video game, each of the characters on an opposing computer-controlled team is an NPC. However, creating game character motions for both player-controlled characters and NPCs that are both engaging and appear realistic to the user has proven to be quite difficult. Ideally, a user of a video game should see the character motion as being “alive” or “correct,” without motion artifacts that appear to jar a character out of context. More specifically, motion artifacts are particularly apparent in animation sequences that transition from a first motion to a second motion.

“Locomotion” refers to periodic, repetitive motions, such as walking, running, jogging, creeping, swimming, and the like. Locomotion may be goal-directed, meaning that a character intelligently navigates a terrain to reach a defined goal while following an unspecified path around obstacles within the terrain. In contrast, “performed motion” refers to motions designed for specific objects, locations, or orientations in the environment. Performed motions may be any motion that is not locomotion. Examples of performed motion include climbing ladders or stairs, sitting down in a chair, fighting with other characters, shooting a gun, jumping over a fence, and the like.

Prior art techniques for transitioning between a first motion sequence and a second motion sequence rely on “motion graphs,” also referred to as “blend trees.” A motion graph is a network of discrete motion clips with connected transitions that linearly blend from one clip into another clip. A problem with using motion graphs to make the transition is that the generated motion may suffer from motion artifacts that cause the appearance of sliding, jumping, skipping, or other changes that look unnatural.

Accordingly, there remains the need in the art for a technique for generating realistic animation sequences that transition between different motion sequences.

### SUMMARY OF THE INVENTION

Embodiments of the present invention provide a method for generating a motion sequence of a character object in a rendering application executing on a computer system. The method includes selecting a first motion clip associated with a first motion class, where the first motion clip is stored in a memory included within the computer system; selecting a second motion clip associated with a second motion class, where the second motion clip is stored in the memory included within the computer system; generating a registration curve that temporally and spatially aligns one or more frames of the first motion clip with one or more frames of the second motion clip; and rendering the motion sequence of the character object by blending the one or more frames of the first motion clip with one or more frames of second motion clip based on the registration curve.

One advantage of the techniques described herein is that they provide for creating motion sequences having multiple motion types while minimizing or even eliminating motion artifacts at the transition points. Another advantage is that the framework provides an intuitive way for a user to create custom motion sequences by restricting the number of possible motion classes to which the motion sequence may transition based on the current motion class of the motion sequence.

### BRIEF DESCRIPTION OF THE DRAWINGS

FIG. 1 is a block diagram illustrating components of a computer system configured to implement one or more aspects of the present invention.

FIG. 2 is a conceptual diagram illustrating motion space building blocks and registration types between the motion space building blocks, according to one embodiment of the invention.

FIG. 3 is a flow chart illustrating a method for pre-processing a plurality of motion spaces when creating a continuous locomotion motion space, according to one embodiment of the invention.

FIG. 4 is a flow chart illustrating a method for a real-time phase of steering a character towards a goal by blending motion clips of a behavioral motion space, according to one embodiment of the invention.

FIG. 5 illustrates a behavioral motion space, according to one embodiment of the invention.

FIG. 6 illustrates two motion clips that may be blended to create an animation sequence of a character performing a running motion, according to one embodiment of the invention.

FIG. 7 illustrates a motion space created by blending the two running motion clips, according to one embodiment of the invention.

FIG. 8 illustrates two motion clips that may be blended to create an animation sequence of a character performing a walking motion, according to one embodiment of the invention.

FIG. 9 illustrates a walking motion space that can be created by the blending of two walking motion clips, according to one embodiment of the invention.

FIG. 10 illustrates an example of how blending weights may be varied over time for animation frames generated using a behavioral motion space 1300, according to one embodiment of the invention.

FIG. 11 is flow diagram of method steps for calculating an ending registration between a continuous locomotion motion class and an ending performed motion class, according to one embodiment of the invention.

FIG. 12 is a conceptual diagram illustrating transitioning from a continuous locomotion motion space to an ending performed motion space, according to one embodiment of the invention.

FIG. 13 is flow diagram of method steps for calculating a leading registration between a leading performed motion class and a continuous locomotion motion class, according to one embodiment of the invention.

FIG. 14 is a conceptual diagram illustrating transitioning from a leading performed motion space to a continuous locomotion motion space, according to one embodiment of the invention.

FIG. 15 is flow diagram of method steps for calculating an enveloping registration from a continuous locomotion motion class to a discontinuous and/or interrupted locomotion motion class and back to a continuous locomotion motion class, according to one embodiment of the invention.

FIG. 16 is a conceptual diagram illustrating transitioning from a continuous locomotion motion space to a discontinuous performed motion space and back to a continuous locomotion motion space, according to one embodiment of the invention.

FIG. 17 is a block diagram of a computer system 1700 configured to implement one or more aspects of the present invention.

### DETAILED DESCRIPTION OF THE PREFERRED EMBODIMENTS

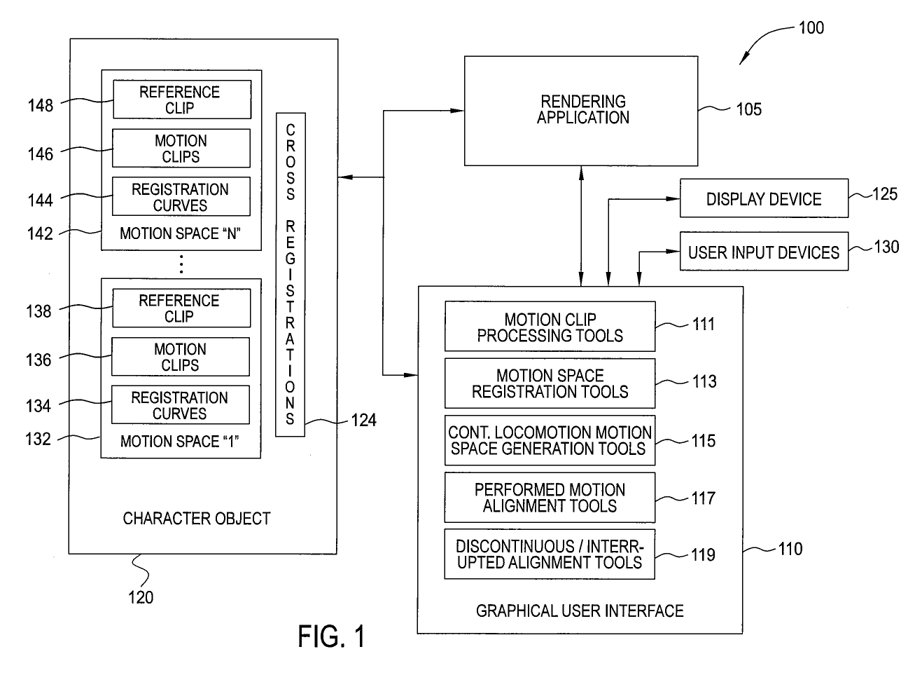

FIG. 1 is a block diagram illustrating components of a computer system 100 configured to implement one or more aspects of the present invention. The computer system 100 can be any type of computing system, including a desktop computer, a server computer, a laptop computer, a tablet computer, and the like. Software applications described herein, however, are not limited to any particular computing system and may be adapted to take advantage of additional computing systems as they become available.

As shown, the computer system 100 may include a rendering application 105, a graphical user interface 110, a character object 120, a display device 125, and user input devices 130. Those skilled in the art will recognize that the components shown in FIG. 1 are simplified to highlight aspects of the present invention and that a typical rendering application 105 and GUI interface 110 may include a broad variety of additional tools and features used to compose and manage the character object 120. Additionally, the components of computer system 100 may include software applications executing on distributed systems communicating over computer networks, such as local area networks or large, wide area networks, like the Internet. For example, the graphical user interface 110 may include a software program executing on a client computer system communicating with the rendering application 105 residing at another physical location. As would be understood by persons having ordinary skill in the art, the computer system 110 could include many other components not shown in FIG. 1. For example, the computer system 100 may include a memory that stores instructions associated with the rendering application and a processor that executes the instructions.

Rendering application 105 may be configured to allow users interacting with GUI interface 110 to compose character object 120. Accordingly, rendering application 105 and GUI interface 110 may include programmed routines or instructions allowing users to create, edit, load, and save the character object 120. Typically, user input devices 130 include a mouse, a pointing device, a keyboard, a joystick, or a video game controller, and display device 125 may be a CRT or LCD display.

The character object 120 may be associated with one or more motion spaces 132, 142. In one embodiment, the motion spaces 132, 142 may define the range of motion of the character object 120. Illustratively, each motion space 132, 142 includes motion clips 136, 146, registration curves 134, 144, and a reference clip 138, 148. In one embodiment, motion clips 136, 146 may be pre-defined motion clips created using a motion capture system. Within a given motion space, each of the motion clips are of the same motion “type,” e.g., running, walking, or sitting in a chair, among others. In another embodiment, users of the rendering application 105 may create new motion clips 136, 146 manually by creating a sequence of key-frames using standard three-dimensional (3D) computer animation key-framing tools.

Motion clips 136, 146 may include a sequence of frames of geometrical primitives such as points, lines, curves, and polygons that collectively depict character object 120 performing some form of motion. For example, motion clips 136, 146 may include a sequence of frames that depict a wire-frame skeleton of a human engaging in a walking motion. The character's skeleton motion may be described as a hierarchical set of bones connected by moving joint angles as the character's root body position travels through its virtual 3D environment. A “skeletal deformation” of a character model's body surface geometry along with texture mapping may then be used to give the geometrical primitives that make up character object 120 a life-like appearance. As is known, texture mapping is a method of adding detail, surface texture, or color to a computer-generated graphic or model.

Registration curves 134, 144 within each motion space 132, 142 may define a relationship between individual frames of a first motion clip and corresponding frames of a second motion clip in the motion space 132, 142. Registration curves 134, 144 provide a data structure specifying the relationships involving the timing, local coordinate frame, and constraints between frames of the first motion clip and corresponding frames of the second motion clip.

Additionally, registration curves 134, 144 may be used to expand the range of motion that can be automatically blended from the motion clips of a motion space without requiring manual intervention. For example, one motion clip may depict a walking character turning 30 degrees to the right and a second motion clip may depict the walking character turning 30 degrees to the left. The registration curve created for such first and second motion clips may be used for generating an animation clip blended from the first and second motion clips. Further, depending on how frames from motion clips are blended, the resulting animation clip may show the character moving anywhere within the motion space between the two motion clips. Thus, in this example, the resulting animation clip may show the character walking while gradually turning anywhere from one extreme (30 degrees to the right) to the other (30 degrees to the left) or anywhere in between.

As described in greater detail below, motion spaces of different motion types may be used as “building blocks” to generate a sequence of motion. In one embodiment, each motion space may be categorized into one of six “motion classes,” including (1) a continuous locomotion motion space class, (2) an ending performed motion space class, (3) a stationary performed motion space class, (4) a leading performed motion space class, (5) a discontinuous locomotion motion space class, or (6) an interrupted locomotion motion space class. For example, a “continuous locomotion motion space” class may include motion clips of a character walking in different directions; whereas, a “stationary performed motion space” class may include motion clips of a character sitting in a chair crossing and uncrossing their legs.

In one embodiment, one of the motion clips in a motion space is designated as a reference clip 138, 148. The reference clip 138, 148 may provide a representative clip of the motion space. For example, for a motion space representing a walking character motion, the reference clip may depict the character walking in a generally straight line for a number of steps. In another example, for a motion space representing a character sitting down in a chair from a standing position, the reference clip may depict the character approaching a chair and turning 180 degrees to sit down in the chair. The reference clips may be used to generate cross registration curves between two motion spaces.

Cross registrations 124 may be made between motions clips 136, 146 of multiple motion spaces 132, 142, including the reference clips 138, 148. Similar to registration curves 134, 144 within a motion space, the cross-registrations 124 are used to blend different types of motion represented by various motion spaces 132, 142. In one embodiment, additional cross registrations 124 may be made between “non-reference clip” motion clips, allowing for more accurate blending across motion spaces. For example, these additional cross registrations may more accurately blend a time step of the motion, i.e., how far to advance through a motion space from frame-to-frame when blending between different motion types.

Graphical user interface 110 (GUI 110) provides tools used to manipulate character object 120. In one embodiment, the GUI 110 may provide an authoring toolkit that enables a user to create arbitrary motion sequences that transition between motion spaces of various motion categories (e.g., from a continuous locomotion motion space to an ending performed motion space). As shown, GUI 110 includes motion clip processing tools 111, motion space registration tools 113, continuous locomotion motion space generation tools 115, performed motion alignment tools 117, and discontinuous and/or interrupted motion space alignment tools 119. Those skilled in the art will recognize that the tools of GUI 110 is simplified to highlight aspects of the present invention and that a typical rendering application 105 and GUI 110 may include a broad variety of additional tools and features used to compose and manipulate an animated character object 120.

Motion clip processing tools 111 may provide GUI elements that allow a user to define and modify physical, display, and meta properties of motion clips 136, 146. As stated, motion clips 136, 146 may provide a sequence of frames showing the character performing some form of motion.

Motion space registration tools 113 may provide GUI elements that allow a user to generate a motion space by causing the rendering application 105 to determine registration curves between motion clips of the same type. For example, a first motion clip may depict of a character walking gradually to the left and a second motion clip may depict of a character walking gradually to the right. The rendering application 105 may calculate a registration curve between the first and second motion clip, thus defining the motion space. As described in greater detail herein, by varying a blend weight associated with the first and second motion clips, a user may create an animation sequence that depicts the character walking gradually to the left, gradually to the right, or anywhere in between the two motion clips.

Continuous locomotion motion space generation tools 115 may provide GUI elements that allow a user to create an animation sequence for the character object 120 that extends a locomotion portion of the animation sequence indefinitely. Each motion clip, and hence each motion space that includes a set of motion clips, has a finite length. As a result, if a user generates an animation sequence by blending the frames of two motion clips, then the resulting animation sequence also has a finite length. In many applications that involve character animation, especially those that involve NPC animation, characters may move around the scene for an arbitrary period of time. Accordingly, embodiments of the invention provide a “looping” motion space that may be used to render the character object 120, where the character object 120 performs an arbitrary number of motion cycles, particularly a periodic locomotion such as when a human character walks, jogs, or runs, among others. In one embodiment, to create a looping motion space, the motion clips in a motion space are processed to include the same number of locomotion cycles and to have matching first and last frames. Registration curves between the processed motion clips may be generated, allowing for the processed motion clips to be seamlessly blended together. These blended motions can be “looped” any number of times, without generating any abrupt changes in the character's motion.

Continuous locomotion motion space generation tools 115 may be used to combine motion clips 136, 146 of multiple motion spaces 132, 142 into a “behavioral” motion space. A “behavioral” motion space, as used herein, is a motion space that combines the motions of two or more locomotion motion spaces so that the frames of motion of various locomotion styles may be synchronized, combined, and continuously varied by means of blend weights for each of the two or more locomotion motion spaces. In other words, the locomotion style of a character may be seamlessly and convincingly changed at any time as the character moves through the environment. As stated, similar to the way blending of motion clips within a motion space may be used to vary the path of a character, blending of motion spaces into a behavioral motion space may be used to transition the character from one style of motion to another. For example, a motion sequence may depict a character transitioning from walking to jogging to running. Additionally, different types of hybrid motion may be created by blending different locomotion types, e.g., a “running-walk.” Thus, rather than providing a handful of sharply distinct locomotion types, the rendering application 105 is configured to provide broad ranges of motion that may be blended to create the behavioral motion space, resulting in rendered character motions with more realistic appearances.

In one embodiment, a rendering application 105 may include goal space steering tools (not shown). A goal is a target to which a character desires to move. The goal can be either stationary or moving. Goal space steering tools may vary the blending weight of motion clips within a motion space to continuously turn a character in real-time towards a stationary or moving goal. Due to the irregular curvature of blended motion clip paths, the relationship between blending weight and direction is not analytically computable. For example, each footstep taken by a character should not be perfectly smooth along a line or arc, because without natural irregularities in the motion, such as lateral shifts in balance, differences in stride length, and deviations in path direction, the character's motion would be perceived as being “robotic.” In short, motion data cannot be described by a closed-form parametric equation that gives motion direction as a function of blending weight. Given the irregularity of the motion data, for each frame of the rendered animation sequence, the correct blending weight coefficients may be used in conjunction with registration curves and cross registrations to steer a character toward a desired goal location. In one embodiment, the goal location may define a location in an environment at which the character initiates a performed motion that may be specifically oriented within the environment.

Performed motion alignment tools 117 may allow a user to align a sequence of locomotion with an arbitrarily placed and rotated performed motion. In one embodiment, the alignment is based on pre-computing coordinated footstep plans that connect with rotated variations of the performed motion within a contiguous and bounded region. Additional details describing pre-computing coordinated footstep plans for a transition between a locomotion motion space and a performed motion space are described in U.S. patent application Ser. No. 12/128,580, filed on May 28, 2008 (Attorney Docket No. AUTO/1136), which is hereby incorporated by reference in its entirety.

Discontinuous and/or interrupted motion space alignment tools 119 may allow a user to align a sequence of locomotion with an arbitrarily placed and rotated discontinuous and/or interrupted motion. A “discontinuous motion space” is a motion space defined by a sudden change of direction of the character. For example, the character may be running forward and may then perform a 90-degree turn. An “interrupted motion space” is a motion space defined by locomotion broken by a behavior (e.g., sprinting, then jumping over a fence, then sprinting again). In one embodiment, the motion of a discontinuous locomotion motion space is still characterized a regular pattern of motion (e.g., left foot, right foot, left foot, right foot, etc.); whereas the motion of an interrupted locomotion motion space is irregular (e.g., left foot, right foot, performed motion, left foot, etc.). In one embodiment, the alignment of discontinuous and/or interrupted motion is based on pre-computing coordinated footstep plan that connect a locomotion to a rotated variation of the discontinuous and/or interrupted motion, and from the discontinuous and/or interrupted motion back to a locomotion.

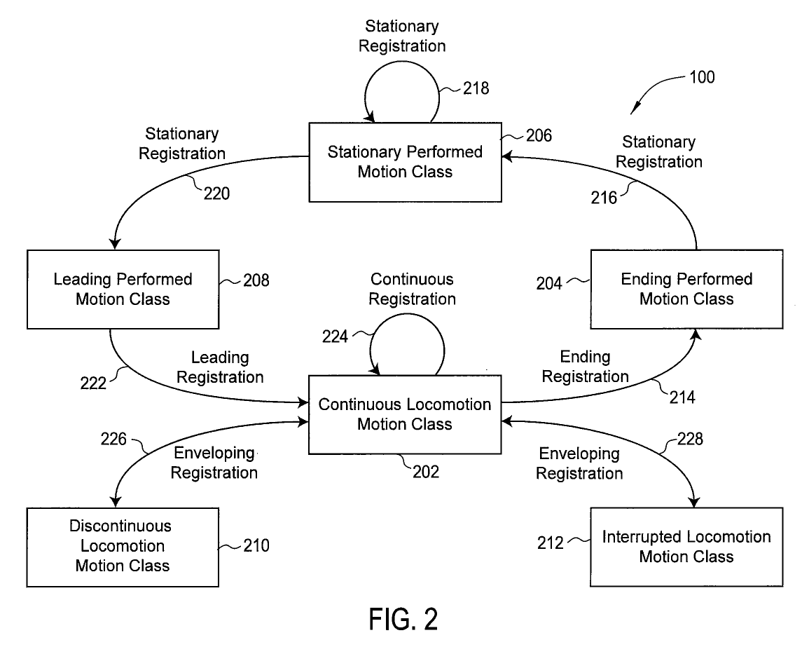

FIG. 2 is a conceptual diagram 200 illustrating motion space building blocks and registration types between the motion space building blocks, according to one embodiment of the invention. As shown, the conceptual diagram 200 includes (1) a continuous locomotion motion spaces 202, (2) an ending performed motion space building block 204, (3) a stationary performed motion space building block 206, (4) a leading performed motion space building block 208, (5) a discontinuous locomotion motion space building block 210, and (6) an interrupted locomotion motion space building block 212. In one embodiment, each motion space building block 202, 204, 206, 208, 210, 212 corresponds to a different one of six motion classes. As described in greater detail herein, each of the six different motion classes is characterized by a different type of motion. Additionally, each of the six different motion classes is associated with different registration types that define how each motion class may be operationally combined with other motion classes. Additionally, the conceptual diagram 200 includes transitions between the motion space building blocks, including an ending registration 214, stationary registration 216, 218, 220, leading registration 222, continuous registration 224, and enveloping registration 226, 228.

The continuous locomotion motion space building block 202 corresponds to a motion class defined by periodic, repetitive motions, such as walking, running, jogging, creeping, swimming, and the like. The ending performed motion space building block 204 corresponds to a motion class defined by a non-periodic motion that is performed following a sequence of locomotion (e.g., sitting down in a chair following a sequence of locomotion). In one embodiment, a performed motion is any motion that is not locomotion. The stationary performed motion space building block 206 corresponds to a motion class defined by a non-periodic motion that is performed while the character is not moving (e.g., while sitting in a chair with both feet on the floor, the character crosses one leg over the other). The leading performed motion space building block 208 corresponds to a motion class defined by a non-periodic motion that is performed before a sequence of locomotion (e.g., a character standing up from a sitting positing and beginning a series of locomotion). The discontinuous locomotion motion space building block 210 corresponds to a motion class defined by a sudden change of direction of the character. For example, the character may be running forward and may then perform a 90-degree turn. The interrupted locomotion motion space building block 212 corresponds to a motion class defined by locomotion broken by a behavior (e.g., sprinting, then jumping over a fence, then sprinting again).

According to one embodiment of the invention, all motions can be categorized into one of the six motion classes described above. Each motion class may include motion clips and/or motion spaces. Each registration type, in turn, defines how each motion class may be operationally combined with other motion classes.

Ending registration 214 is defined by transitioning from a continuous locomotion motion class to an ending performed motion class. In one embodiment, the motions included in the ending performed motion class are defined by a lead-in locomotion portion and a performed motion portion. The continuous locomotion motion class may be registered with the lead-in locomotion portion of the ending performed motion class.

Stationary registration 216 is defined by transitioning from an ending performed motion class to a stationary performed motion class. Stationary registration 218 is defined by transitioning from a stationary performed motion class to another stationary performed motion class. Stationary registration 220 is defined by transitioning from a stationary performed motion class to a leading performed motion class. Stationary registrations 216, 218, 220 may be performed by blending between two motion clips and/or motion spaces at places along the motion where there is a reasonable amount of continuity between the motions. Various conventional techniques may be used to compute the stationary registration. One example is described in Kovar et al., “Automated Extraction and Parameterization of Motions in Large Data Sets,” ACM Trans. Graph, Volume 23, Issue 3, pp. 559-568 (August 2004).

Leading registration 222 is defined by transitioning from a leading performed motion class to a continuous locomotion motion class. In one embodiment, the motions included in the leading performed motion class are defined by a performed motion portion followed by a lead-out locomotion portion. In one embodiment, the lead-out locomotion portion of the leading performed motion class may be registered with the continuous locomotion motion class.

Continuous registration 224 is defined by transitioning from a continuous locomotion motion class to another continuous locomotion motion class. In one embodiment, “looping” between motion spaces, as described herein, is one example of continuous registration.

Enveloping registration 226 is defined by transitioning from a continuous locomotion motion class to a discontinuous locomotion motion class, and then transitioning back to a continuous locomotion motion class. In one embodiment, a discontinuous locomotion motion class is defined by a motion having a lead-in locomotion portion, which is followed by a discontinuous motion (e.g., sharp turn), which is followed by a lead-out locomotion portion. The incoming continuous locomotion motion class may be registered with the lead-in locomotion portion of the discontinuous performed motion class; whereas, the outgoing continuous locomotion motion class may be registered with the lead-out locomotion portion of the discontinuous performed motion class. In one embodiment, the continuous locomotion motion clip and/or motion space between which the transitions are made is the same on both sides of the enveloping registration 226. For example, a walking motion space may transition to a sharp turn motion space and then back to a walking motion space. In alternative embodiments, the continuous locomotion motion clip and/or motion space between which the transitions are made is different on each sides of the enveloping registration 226. For example, a walking motion space may transition to a sharp turn motion space and then to a running motion space. In still further embodiments, the continuous locomotion motion space on both sides of the enveloping registration 226 is a behavioral motion space.

Similar to the enveloping registration 226, enveloping registration 228 is defined by transitioning from a continuous locomotion motion class to an interrupted locomotion motion class, and then transitioning back to a continuous locomotion motion class. In one embodiment, a interrupted locomotion motion class is defined by a motion having a lead-in locomotion portion, which is followed by an interrupted locomotion motion (e.g., jump over a fence), which is followed by a lead-out locomotion portion. The incoming continuous locomotion motion class may be registered with the lead-in locomotion portion of the interrupted locomotion motion class; whereas, the outgoing continuous locomotion motion class may be registered with the lead-out locomotion portion of the interrupted locomotion motion class.

In an alternative embodiment, the discontinuous performed motion class and the interrupted locomotion motion class may be combined into a single motion class so that the animation framework includes five different motion classes, not six different motion classes.

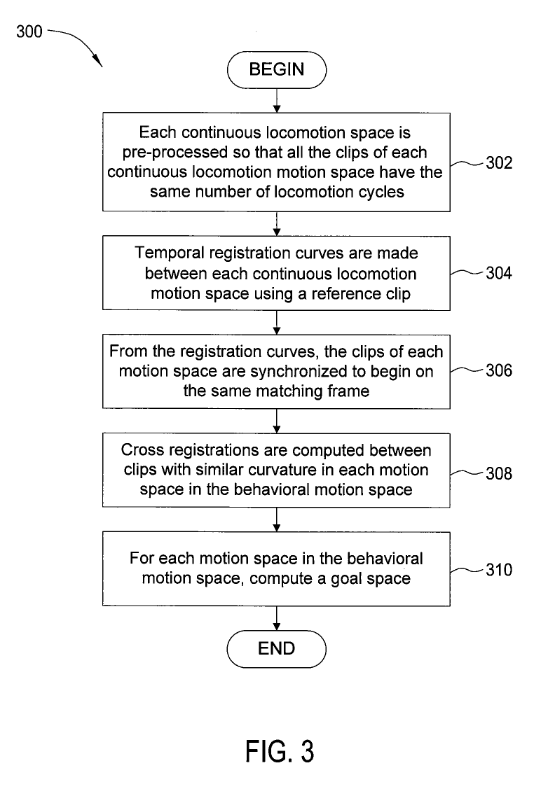

Additional details surrounding each different motion class and the different registration types between motion classes is described in greater detail in FIGS. 3-16.

One embodiment of the invention provides a framework for a user to create an arbitrary motion sequence based on one or more motion classes and one or more registrations between the one or more motion classes. The framework can be conceptually organized into an “authoring component” and a “run-time component.” The authoring component is based on organizing all motion into six motion classes (or five motion classes in some embodiments where the discontinuous locomotion motion class is grouped together with the interrupted locomotion motion class), as described herein. The run-time component is based on how the rendering application determines how to properly transition between the different motion classes so that the final motion sequence minimizes visual artifacts.

In one embodiment, a library of motions may be included with the rendering application, where each motion clip is categorized into one of the six motion classes. Additionally, a user may create additional motion clips (e.g., manually or by motion capture). The user may then classify the user-created motion clips into one of the six motion classes. In some embodiments, a motion may be split apart into two or more distinct motion clips, where one motion clip is classified in a first motion class and another motion clip is classified in a second motion class. In some embodiments, the rendering application may provide a function that analyzes the motion of a motion clip and automatically characterizes the motion clip into one of the six motion classes based on the movement of the primitives included in the motion clip.

Based on this framework, as long as the motions are properly categorized, then seamless transitions are possible between motion classes based on the registration described in FIG. 2. As shown, the registrations described in FIG. 2 are represented by arrows between motion space classes. In some embodiments, one or more of the arrows between motion spaces are one-sided, indicating that a transition is only possible in one direction and not the other direction. For example, if a user creates a motion sequence that begins with a continuous locomotion motion class, the motion sequence may transition to either (a) an ending performed class (via an ending registration 214), (b) an interrupted locomotion motion class (via an enveloping registration 228), (c) a discontinuous locomotion motion class (via an enveloping registration 226), or (d) a continuous locomotion motion class (via a continuous registration 228). As shown in FIG. 2, the motion cannot transition from the continuous locomotion motion class to the leading performed motion class or to the stationary performed motion class.

Additionally, in some embodiments, when transitioning from a first motion class to a second motion class, and then from the second motion class to a third motion class, the contribution of the second motion class to the overall motion sequence may be arbitrarily long or arbitrarily short. For example, the second motion class may contribute to multiple frames of the motion sequence comprising several seconds or longer. In another example, the second motion class may contribute only a single frame to the overall motion sequence.

In still further embodiments, one or more registrations shown in FIG. 2 are omitted and/or one or more additional registrations are added to the framework. For example, in some embodiments, a motion sequence may transition directly from the ending performed motion class to the leading performed motion class, skipping the stationary performed motion class. In another example, in some embodiments, a motion sequence may transition from either the discontinuous locomotion motion class or the interrupted locomotion motion class directly to the ending performed motion class, skipping the continuous locomotion motion class. However, in these embodiments, additional configuration may be required to ensure that the user does not attempt to transition the motion sequence to the ending performed motion class from the discontinuous locomotion motion class or the interrupted locomotion motion class during the performance of a discontinuity (e.g., turning sharply) or interrupted motion (e.g., jumping over a fence).

In one embodiment, GUI elements, such a list box, may be provided that allow the user to readily determine to which different motion class the motion sequence may transition based on the current motion class. Accordingly, the rendering application may provide GUI elements for users to build custom motion sequences using a sort of “motion algebra” in the form of:

MotionSequence=MotionSpace₁<op₁>MotionSpace₂ . . . <opm>MotionSpace_{N}

The operators <opₘ> may represent a registration operation that combines motions, and the motion spaces (e.g., MotionSpace_{N}) may represent a motion class of similar or common motion clips that may be blended to form a motion segment of the overall motion sequence. As described in greater detail herein, one embodiment of the invention provides for a two-phase blending process. First, motion clips within a first motion space are blended together to generate a first blended pose, and motion clips within a second motion space are blended together to generate a second blended pose. Second, the first and second blended poses are blended using cross-blend weights and cross-registrations between motion spaces. In some embodiments, the motion that is contributed from one or more motion spaces may be unblended, meaning that the motion is derived from a single motion clip from a motion space and not from a blend of two or more motion clips from the motion space.

FIG. 3 is a flow chart illustrating a method 300 for pre-processing a plurality of motion spaces when creating a continuous locomotion motion space, according to one embodiment of the invention. Persons skilled in the art will understand that even though method 300 is described in conjunction with the systems of FIGS. 1-2, any system configured to perform the steps of the method 300, in any order, is within the scope of the present invention. Further, persons skilled in the art will understand that the steps of the method 300 are only one embodiment of the present invention.

As shown, method 300 begins at step 302, where the rendering application pre-processes the motion clips in each continuous locomotion motion space so that all clips of each continuous locomotion motion space have the same number of locomotion cycles. For example, a user may want to create a motion sequence that is a blend of a walking motion space and a running motion space, where each motion space is made up of individual motion clips. Motion clip A may be a walking clip with six locomotion cycles (i.e., six walking steps). Motion clip B, however, may be a walking clip that includes only four locomotion cycles (i.e., four walking steps). At step 302, the motion clips are pre-processed to have the same number of periodic cycles, bounded by the number of periodic cycles in the shortest clip. Thus, in this example, each motion clip in the walking motion space is processed to have a maximum of four periodic cycles because the shortest clip (motion clip B) has four cycles. This process is repeated for each continuous locomotion motion space.

Although step 302 may be done using conventional manual editing techniques available in some commercial software, an alternative approach exploits properties of motion registration to create loops automatically using a match web. A match web is a graph representation that records the similarity of a character's pose as a “distance” with one motion clip's frames along a horizontal X axis and a second motion clip's frames along a vertical Y axis. An algorithm then determines, based on the motion segments in the match web, the proper registration curve by determining which frames, given a sufficiently large distance threshold, may be considered numerically similar. For example, one algorithm for computing the registration curve using a match web includes Dijkstra's “dynamic programming” algorithm, which may be used to identify the shortest path through the match web. When match webs of periodic locomotion clips are registered with themselves, a series of diagonal minimal cost chains appear that correspond with each phase alignment between matching locomotion cycles. If a registration curve is computed for each matching phase chains, since the clip is being compared against itself, then the registration along the middle diagonal is a straight line and the curves on each side are a symmetrical mirror with respect to this middle diagonal line. The number of curves below the diagonal corresponds with the number of locomotion cycles in the motion clip.

Furthermore, as is known, each registration curve may be selected to produce a desired number of periodic cycles in a resulting loop, with the uppermost longer curves below the middle diagonal producing the maximum number of cycles. Continuing with the above example of two motion clips A and B of six and four locomotion cycles, respectively, suppose a registration curve is desired for two clips each having three locomotion cycles. A motion clip having six periodic cycles may be created that includes six registration curves in the match web below the diagonal, and, the rendering application may count and select the desired registration curve that corresponds with three cycles (that is, by counting down three from the top: six, five, four, then three). This process may be computed for each motion clip in the motion space so that all motion clips have three period cycles (or other desired number).

Also, the pose of the character in the first frame and the last frame of each motion clip may be configured to substantially match one another. Thus, as a result of the processing performed as part of step 302, each motion clip may include the same number of periodic cycles, and each motion clip begins and ends on substantially the same frame, relative to itself. Therefore, each individual motion clip creates a loop of the periodic motion cycle depicted in that looped motion clip. Additionally, the rendering application may synchronize the motion clips so that each one begins on a frame that is in phase with a matching frame in other motion clips included in the motion space. Because each motion clip includes a loop with the same number of cycles of periodic motion, any frame may be selected as the starting frame. For example, for a walking motion, the frames of multiple motion clips may be sequenced so that each one begins with the character about to take a step with a right foot. Thus, each motion clip in the motion space may include multiple cycles of periodic motion, where each motion clip begins at the same phase through the cycle as the other sequences included in the looping motion space.

Furthermore, the rendering application may pad each motion clip so that the pose of the character in the first and last frames are identical. In one embodiment, a motion clip stores, at each frame, the rotation angles of the character's joints and the translational position of the character's root position. When new frames are chosen to start a motion loop, translational information in the motion may be retained. A “padding” operation is executed that first copies a two-frame frame segment that starts with the frame that precedes the “in phase” starting frame. After the loop is cycled to begin on a desired new starting frame, this two-frame segment may then be appended onto the last frame, thus retaining the incremental positional offset from the preceding frame to the duplicated pose at the last frame. Alternatively, this “padding” operation may be computed by explicitly storing a set of velocity vectors from the preceding frame with each frame's pose, and then reconstructing each frame's position from these incremental velocities after appending the new starting frame at the end. Using the motion space registration techniques, a synchronized frame may be computed for each motion clip, with the synchronized frame becoming the starting (and ending frame) of each motion clip. Further, each motion clip in the motion space begins and ends on the same synchronized frame. In one embodiment, the pre-processing step 302 is performed on each continuous locomotion motion space.

At step 304, the rendering application generates temporal registration curves between each of the continuous locomotion motion spaces based on the reference clip specified for each individual continuous locomotion motion space. Because each motion clip in a motion space is synchronized with one another, registration curves may be computed to match frames of a first motion clip of a first motion space to frames of other motion clips in the first motion space. Thus, the motion clips included in the first motion space may be blended to create an animation clip anywhere inside the first motion space. Because of the specific properties of the individual motion clips (e.g., identical first and last frames), the blended sequence can be looped without introducing artifacts into the looped animation, regardless of the blending weights used to create any of the frames of the looped animation.

Similarly, the reference clip may be used to synchronize a plurality of motion spaces, each representing a different form of motion. A reference clip, in one embodiment, is a standard or representative clip from each motion space. For example, a clip may be taken from each motion space that depicts the character walking, running, jogging, or creeping in a generally straight line to be the reference clip for each motion space. The reference clips may be registered with one another using the methods described above for synchronizing motion clips within a single motion space. For example the reference clip of a “jogging” motion space may be registered with a reference clip of a “walking” motion space. Once these two reference clips are synchronized, the synchronization can be passed down to the other motion clips within each motion space because the reference clip has already been pre-processed to be synchronized with the other motion clips in the motion space. Thus, each of the motion clips in the jogging motion space is synchronized with each of the motion clips in the walking motion space. If a third motion space, for example, a “running” motion space, is introduced, a reference clip from the running motion space may be synchronized with either the reference clip of the jogging motion space or the reference clip of the walking motion space. Doing so would synchronize each of the motion clips in each of the three motion spaces.

At step 306, the rendering application synchronizes the motion clips of each motion space to begin on the same matching frame based on the registration curves. This may be done using the methods described above in relation to synchronizing motion clips within a single motion space.

At step 308, the rendering application computes cross registrations between clips with similar curvature in each continuous locomotion motion space. Although the reference clip temporal registrations are sufficient for determining matching frames between motion spaces, these additional registrations may improve the accuracy for taking the next time-step (for the next frame) relative to the most heavily weighted clips in the motion spaces, as described above.

At step 310, the rendering application computes a goal space for each continuous locomotion motion space. In one embodiment, step 310 is optional and is omitted.

In one embodiment, the goal space may be used to store a collection of possible future locations of a character, based on a number of different “starting frames” (e.g., frames where a walking character's heel strikes the ground). For each “starting” frame, the goal space table may store a number of ending locations of the character that would result some number of frames in the future, based on different beginning and final blending weights. The goal space may be stored in a table. In one embodiment, the table may be indexed by a beginning blending weight and frame sequence number.

For example, assume the goal space is defined to include “X” starting frames with “Y” beginning blend values and “Z” final blend values for a future ending time that is “F” frames in the future for each of the “X” starting frames. In such a case, the total number of future locations in the goal space is equal to X*Y*Z. For a walking motion space where each loop has X=7 footsteps, the starting frames could correspond with the heel strikes of each of the six footsteps. For each footstep, the goal space table could include Z=35 different final blending weights future locations for Y=13 different starting blending weights. This results in a goal space with a total number of 7*35*13=1950 future positions, 425 for each of the 7 starting frames.

When the goal space table is computed, both the starting and final blending weights may span the full range of blending weights in the motion space. In one embodiment, during rendering, however, the blending weight may only be allowed to change by a fixed rate per frame, say 0.1 units. By constraining the rate of change in the blending value from any one frame to the next, the quality of the resulting animation sequence is improved as large changes in the blending weight may lead to rendered frames with visual artifacts where the character object appears to suddenly change direction in an unrealistic manner.

In one embodiment, the goal space table may be used during rendering to steer a character object towards a given goal position. Continuing with the example, above, the rendering application may calculate a blending value at each of the X=6 heel strike frames during rendering, (i.e., for each frame where the goal space includes a future position lookup). Note, however, each time a new blending value is determined it may take some time before frames are actually blended using that value. Instead, once determined, the rendering application may transition from a then current blending value to a new one over some number of frames. Computing a goal space, as described with reference to step 310, is computed for each motion space in the behavioral motion space.

In one embodiment, steps 302, 304, 306, and 308 collectively describe one technique for a rendering application to determine continuous registrations 224 between continuous locomotion motion spaces 202. In alternative embodiments, other techniques beside those described in FIG. 3 may be used by a rendering application to determine the continuous registrations 224.

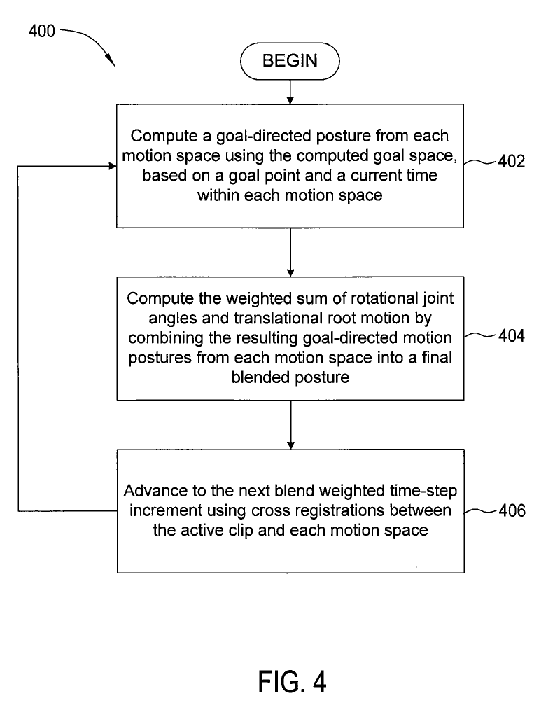

In embodiments where the motion sequence is goal-directed, FIG. 4 is a flow chart illustrating a method 400 for a real-time phase of steering a character towards a goal by blending motion clips of a behavioral motion space, according to one embodiment of the invention. Persons skilled in the art will understand that even though method 400 is described in conjunction with the systems of FIGS. 1-2, any system configured to perform the steps of the method 400, in any order, is within the scope of the present invention. Further, persons skilled in the art will understand that the steps of the method 400 are only one embodiment of the present invention.

As shown, the method 400 begins at step 402, where the rendering application computes a goal-directed posture from each motion space using the computed goal space, based on a goal point and a current time within each motion space. To determine the posture, the rendering application may compute a “steer space” as a function of the current blend value and current frame. In one embodiment, the steer space may include a set of future locations of the character, determined from an interpolation of future positions in the goal space specified for the two “Y” beginning blending values that are closest to the actual current blending value being used to render animation frames. Continuing with the above example, at a given heel strike frame, the rendering application may select a subset of the goal space that corresponds with that frame in the looped cycle. That is, if the goal space includes six “starting” frames, then the rendering application identifies which of the six footsteps is currently being processed. Additionally, the rendering application may further narrow the subset to the two closest Y=13 beginning blend values that are closest to the current blending value. This results in two “fans” of Z=35 future locations, one fan for each of the two “Y” beginning blend values. The rendering application may then interpolate the Z=35 future locations in each of the two fans based on its weighted relative proximity to the then current blend value. The resulting interpolated 35 future positions represent the steer space for the character.

In one embodiment, the interpolation may be performed using polar coordinates as the steer space is used in turning angle control. In an alternative embodiment, one of the “Y” beginning blend values (one fan) is selected rather than interpolating between the two closest “Y” beginning blend values (two fans). Generally, the positions in the steer space represent the future locations that may be reached by the character, based on the current actual position, actual blending value, and changes to the blending value. Thus, in the present example, the steer space equals Z=35 interpolated locations with each location corresponding to a different final blend value that spans from 0.0 (turning to the right) to 1.0 (turning to the left).

The rendering application may determine which steer space samples are closest to the desired goal position. In one embodiment, the rendering application could simply find the two values closest to the goal using a linear distance calculation. Alternatively, as the steer space is used to change the turning direction of the character object, the rendering application could select the goal location(s) in the steer space that are closest to a line between the current character root location and the desired goal location.

The blending coefficients of the closest steer space samples are combined to compute the final blending coefficients. In one embodiment, a k-nearest neighbor average may be computed using two steer space samples. Alternatively, if only one steer space sample is used, the final blending coefficients may be the same as those in the computed “closest” steer space sample. The k-nearest-neighbor algorithm may be used to compute the weighted blends of the selected closest future locations in the steer space. With only k=2 locations, this calculation reduces to a simple linear interpolation based on relative proximity.

At step 404, the rendering application computes the weighted sum of rotational joint angles and translational root motion by combining the resulting goal-directed motion postures from each motion space into a final blended posture. Step 404 may described using the following equation:

$$Frame\_posture = \sum ( blendweights * directed\_posture )$$

The directed posture may be a function of rotational joint angles and the direction of the root. To combine the directions of the root into a final direction, in one embodiment, the rendering application determines a weighted average of the velocity vectors for each motion space in the behavioral motion space. To combine the rotational joint angles, the rendering application may use a normalized quaternion sum. A quaternion is a way of representing rotations with four numbers that represent the orientation of a body in three-dimensional space, often used in games and animation systems.

The frame posture may be a blended weight of each contribution from each motion space. For example, assume that a behavioral motion space includes individual motion spaces for the following four locomotion styles: creeping, walking, jogging, and running. If a user wants to animate a motion described as “jogging almost running,” the blend weights the four motion spaces may be 0.0 creeping, 0.0 walking, 0.5 jogging, and 0.5 running. These blend weights may be used to compute the weighted sum of the rotational joint angles and translation root motion, based on the goal-directed posture for each motion space.

At step 406, the rendering application advances to the next time step using cross registrations between the motion clips that define the blended motion. In one embodiment, during rendering, a time step increment defines how much time lapses between each rendered frame. Continuing with the above example where a blended motion formed from 90% running clips and 10% walking clips, the running clips dominate the blending. Thus, the rendering application may advance a single frame in the running motion space and then advance the walking motion space to synchronize with the running motion space. Cross-registrations between the motion clips that define the blended motion may be useful to more accurately increment the time step. The method 400 then proceeds back to step 402 and repeats for the duration of the blended motion. In one embodiment, the posture of the character is aligned from one motion space to another using a spatial alignment technique. In alternative embodiments, the posture of the character is aligned from one motion space to another using velocity alignment techniques or any other technique. Additionally, one embodiment of the invention provides for blending of motion from different locomotion motion spaces, as described in the example of FIG. 4. Other embodiments provide for blending of motion from different motion spaces, including between motion spaces in a continuous locomotion motion class, an ending performed motion class, a stationary performed motion class, a leading performed motion class, a discontinuous locomotion motion class, and/or an interrupted locomotion motion class, as described in greater detail herein.

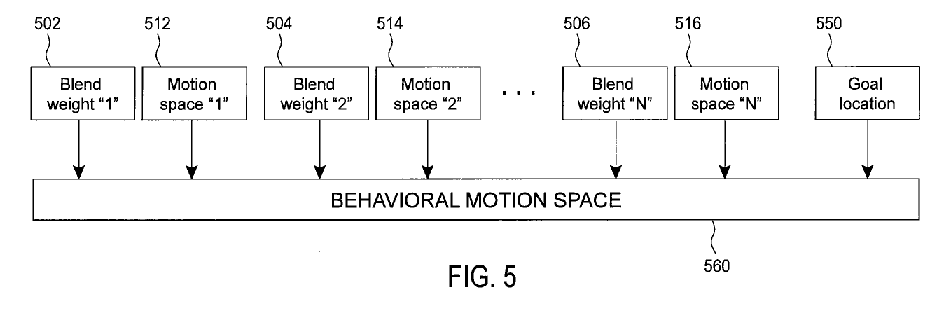

FIGS. 5-7 are conceptual diagrams that describe blending between continuous locomotion motion spaces 202 to generate a “behavioral” motion space.

FIG. 5 illustrates a behavioral motion space, according to one embodiment of the invention. A goal location 550 (optional) and blend weights 502, 504, 506 may be used to combine motion clips from motion spaces 512, 514, 516, to render animation frames in behavioral motion space 560. In this example, motion space 512 represents a walking motion space, motion space 514 represents a jogging motion space, and motion space 516 represents a running motion space. For this example, assume that blend weight 502 is set to 0.3, blend weight 504 is set to 0.7, and blend weight 506 is set to 0.0. Using these example blend weights, the character would be rendered to appear to move towards the goal location 550, such that three-tenths ( 3/10) of the character appearance is contributed by the clips of the walking motion space and seven-tenths ( 7/10) of the character appearance is contributed by the jogging motion space. In this example, the clips of the running motion space contribute nothing to the final motion of the character as the blending weight for this motion space is set to 0.0.

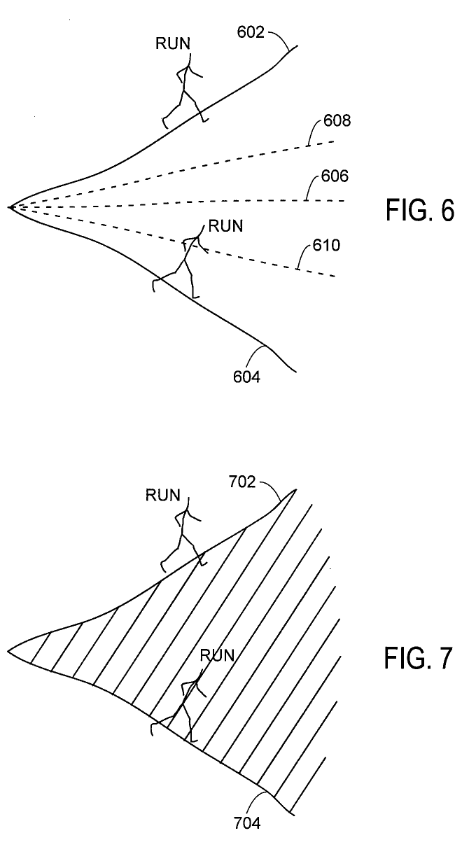

FIG. 6 illustrates two motion clips that may be blended to create a blended path in a running motion space, according to one embodiment of the invention. As shown, clip 602 illustrates a figure that is running at an angle to the left. Clip 604 illustrates a figure that is running at an angle to the right. Note, however, clips 602, 604 are not meant to represent straight lines, as humans do not typically run in perfect lines. Accordingly, when blended together the resulting animation clip is not expected to traverse a truly linear path. In one embodiment, the rendering application may use a registration curve to blend clips 602, 604 to create an animation clip that traverses any desired path through the running motion space. Path 606 illustrates a blended path where clips 602, 604 are equally weighted in computing the path. Path 606 is not a line, but rather a generally straight path. Path 608 is a blended path of clips 602, 604 where clip 602 is more heavily weighted than clip 604. Because clip 602 is more heavily weighted, the path veers more closely to the path followed by clip 602. Similarly, path 610 is a blended path of clips 602, 604 where clip 604 is more heavily weighted than clip 602. Path 610, therefore, veers closer to the path followed by clip 604.

FIG. 7 illustrates a running motion space that can be created by the blending of two running motion clips 702, 704, according to one embodiment of the invention. As shown, clip 702 illustrates a figure that is running at an angle to the left. Clip 704 illustrates a figure that is running at an angle to the right. The shaded area between clips 702, 704 defines the running motion space. A motion sequence can be defined along any path in the running motion space by varying the blending weights of clips 702, 704. In this example, two motion clips are included in the running motion space. Of course, more clips may be used. In one embodiment, when more than two clips are included in the motion space, the two clips closest to the desired path are blended together to generate a frame of a blended animation clip.

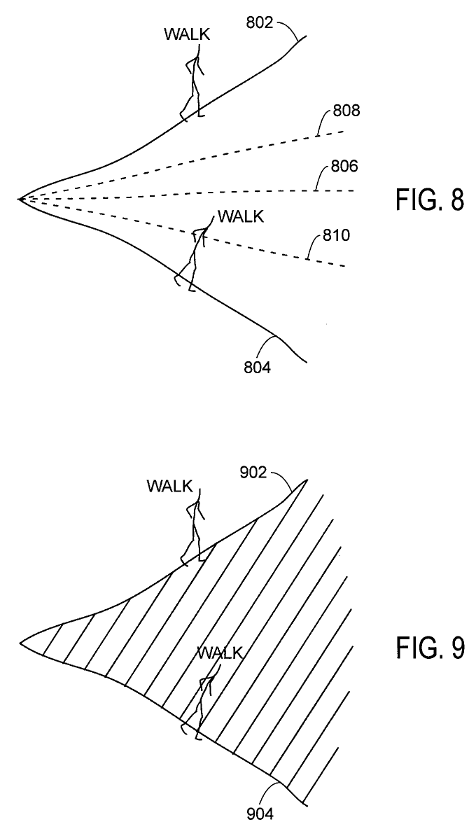

FIG. 8 illustrates two motion clips that may be blended to create a blended path in a walking motion space, according to one embodiment of the invention. As shown, clip 802 illustrates a figure that is walking at an angle to the left. Clip 804 illustrates a figure that is walking at an angle to the right. Similar to the paths shown in FIG. 6, paths 806, 808, 810 may be created by varying the blending weights of clips 802, 804.

FIG. 9 illustrates a walking motion space that can be created by the blending of two walking motion clips, according to one embodiment of the invention. As shown, clip 902 illustrates a figure that is walking at an angle to the left. Clip 904 illustrates a figure that is walking at an angle to the right. The shaded area between clips 902, 904 defines the walking motion space. The walking motion space shown in FIG. 9 may be blended with the running motion space shown in FIG. 7 to create a behavioral motion space, such that the character can be seen as moving in a motion defined by a blend of walking and running.

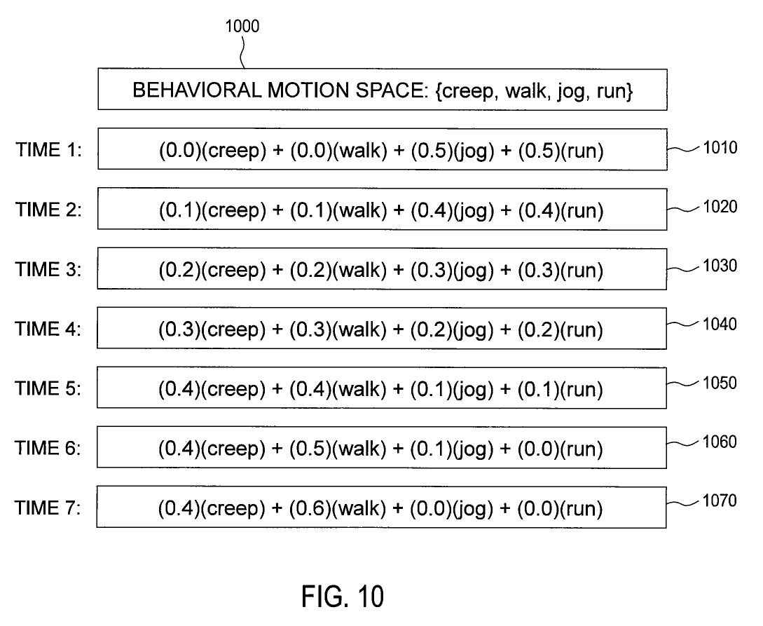

FIG. 10 illustrates an example of how blending weights may be varied over time for animation frames generated using a behavioral motion space 1000, according to one embodiment of the invention. In this example, behavioral motion space 1000 includes four different continuous locomotion motion spaces, including a creeping motion space, a walking motion space, a jogging motion space, and a running motion space. As described above, each of the individual motion spaces may include the same number of periodic locomotion cycles, and the behavioral motion space may include registration curves generated for the motion clips included in the motion spaces. The motion clips within each motion space, and motion clips from different motion spaces, may be registered, as described above.

Illustratively, at time 1, the blending values 1010 are 0.0 creep, 0.0 walk, 0.5 jog, and 0.5 run. Thus, blending values 1010 define a generally “jogging and running” motion. At time 7, blending weights 1070 have changed to 0.4 creep, 0.6 walk, 0.0 jog, and 0.0 run, which define a generally “creeping walk” motion. In one embodiment, the transition between the blending weights at time 1 and the blending weights at time 7 may be gradual. For example, the blending weights at each of the times between time 1 and time 7 may change by a maximum increment of 0.1 at each successive time step, as shown by blending weights 1020, 1030, 1040, 1050, and 1060. In another embodiment, the transition may be implementation-specific. For example, in one implementation the transition may be faster or slower. Using the method of the invention, the transition may be arbitrarily long and continuously changing or may blend animation frames from different motion spaces at a constant rate for an extended sequence. In another embodiment, a transition time could be specified and the rendering application could gradually morph from a first set of blending weights to a second set of blending weights over the allowed transition period.

Additionally, the behavioral motion space may be a “looping” behavioral motion space which continuously loops between one behavioral motion space to another behavioral motion space using a continuous registration 224.

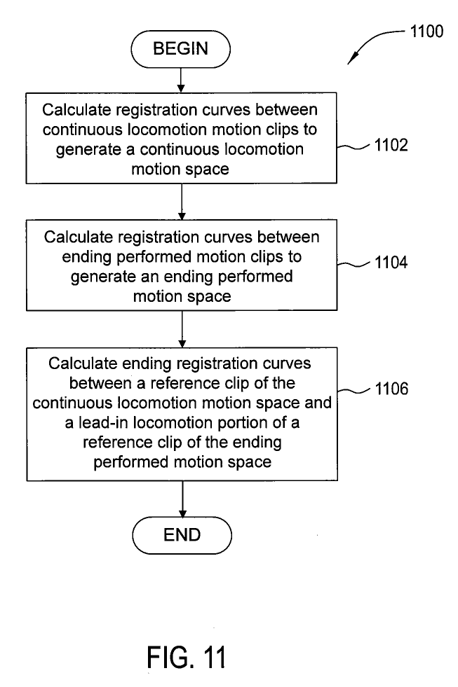

FIG. 11 is flow diagram of method steps for calculating an ending registration between a continuous locomotion motion class and an ending performed motion class, according to one embodiment of the invention. Persons skilled in the art will understand that even though method 1100 is described in conjunction with the systems of FIGS. 1-2 and 5-10, any system configured to perform the steps of the method 1100, in any order, is within the scope of the present invention. Further, persons skilled in the art will understand that the steps of the method 1100 are only one embodiment of the present invention.

As shown, the method 1100 beings at step 1102, where the rendering application calculates registration curves between continuous locomotion motion clips to generate a continuous locomotion motion space. In one embodiment, step 1102 comprises the rendering application performing steps 302 and 304 described in FIG. 3. Examples of continuous locomotion motion spaces are also illustrated in FIGS. 7 and 9. In one embodiment, the continuous locomotion motion space is included in a continuous locomotion motion class.

At step 1104, the rendering application calculates registration curves between ending performed motion clips to generate an ending performed motion space. Again, in one embodiment, step 1104 comprises the rendering application performing steps 302 and 304 described in FIG. 3. For example, two or more motion clips may be provided of a character performing an ending performed motion (e.g., two or more motion clips of a character walking up to a chair and sifting down). The two or more motion clips may be registered together to generate the ending performed motion space. In one embodiment, the ending performed motion space is included in a ending performed motion class.

At step 1106, the rendering application calculates registration curves between a reference clip of the continuous locomotion motion space and a lead-in locomotion portion of a reference clip of the ending performed motion space. As described above, a reference clip of a motion space is a representative motion clip that represents a common or typical motion of the motion space.

In one embodiment, the continuous locomotion motion space includes multiple locomotion cycles. For example, one cycle of a walking motion space comprises a step with a left foot followed by a step with a right foot. In some embodiments, a first registration curve is calculated for transitioning from the continuous locomotion motion space to the performed motion space during one half of the cycle (e.g., transitioning to the performed motion space from the left foot) and a second registration curve is calculated for transitioning from the continuous locomotion motion space to the performed motion space during the other half of the cycle (e.g., transitioning to the performed motion space from the right foot). In this fashion, the transition to the ending performed motion may be made on either half of the cycle.

Additionally, in embodiments where the continuous locomotion motion space includes multiple cycles (e.g., a continuous locomotion motion space that includes steps LEFT, RIGHT, LEFT, RIGHT would include two LEFT/RIGHT cycles), registration curves are calculated for transitioning to the ending performed motion on any portion of any cycle of the continuous locomotion motion space. For example, if the continuous performed motion space includes two cycles of two steps each, then different registration curves are calculated for transitioning to the ending performed motion space from each of the four steps.

Additional details describing various embodiments of calculating a transition between a locomotion motion space and a performed motion space are described in U.S. patent application Ser. No. 12/128,580, filed on May 28, 2008 (Attorney Docket No. AUTO/1136), which is hereby incorporated by reference in its entirety.

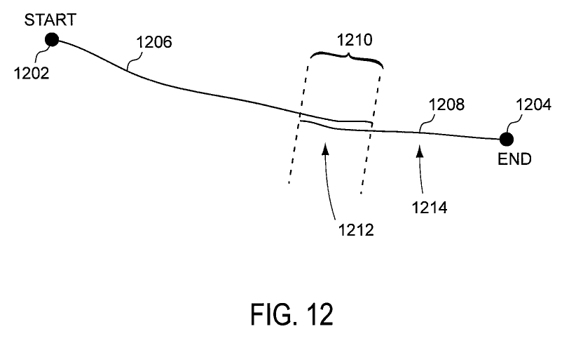

FIG. 12 is a conceptual diagram illustrating transitioning from a continuous locomotion motion space to an ending performed motion space, according to one embodiment of the invention. As shown, a motion sequence begins at point 1202 and ends at point 1204. The motion sequence includes a continuous locomotion motion 1206 and an ending performed motion 1208. The ending performed motion 1208 includes a lead-in locomotion portion 1212 and a performed motion portion 1214.

As shown, the continuous locomotion motion 1206 and the lead-in locomotion portion 1212 of the ending performed motion 1208 overlap at portion 1210. The registration curve calculated for the transition shown in FIG. 12 would allow for a seamless transition from the continuous locomotion motion 1206 to the ending performed motion 1208, minimizing or possibly eliminating motion artifacts.

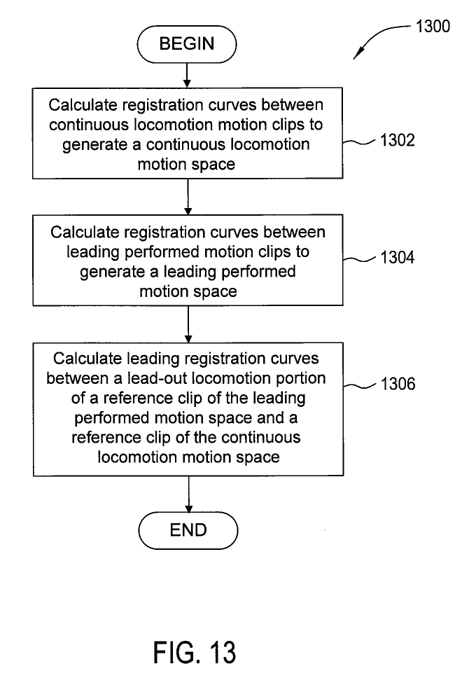

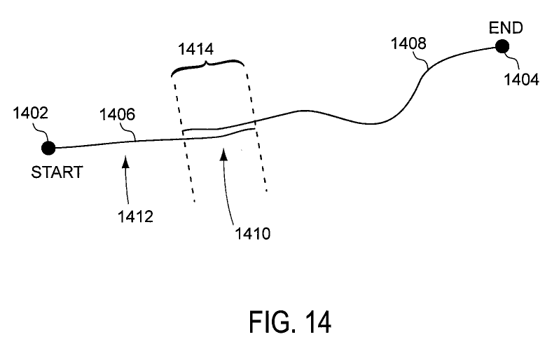

FIG. 13 is flow diagram of method steps for calculating a leading registration between a leading performed motion class and a continuous locomotion motion class, according to one embodiment of the invention. Persons skilled in the art will understand that even though method 1300 is described in conjunction with the systems of FIGS. 1-2 and 5-10, any system configured to perform the steps of the method 1300, in any order, is within the scope of the present invention. Further, persons skilled in the art will understand that the steps of the method 1300 are only one embodiment of the present invention.

As shown, the method 1300 beings at step 1302, where the rendering application calculates registration curves between continuous locomotion motion clips to generate a continuous locomotion motion space. In one embodiment, step 1302 is substantially similar to step 1102 in FIG. 11 and is not described in greater detail herein. In one embodiment, the continuous locomotion motion space is included in a continuous locomotion motion class.

At step 1304, the rendering application calculates registration curves between leading performed motion clips to generate a leading performed motion space. In one embodiment, step 1304 comprises the rendering application performing steps 302 and 304 described in FIG. 3, and is substantially similar to step 1102 in FIG. 11. In one embodiment, the leading performed motion space is included in a leading performed motion class.

At step 1306, the rendering application calculates registration curves between a lead-out locomotion portion of a reference clip of the leading performed motion space and a reference clip of the continuous locomotion motion space. Step 1306 is substantially similar to step 1106, described in FIG. 11, except the order of the transition is reversed. More specifically, at step 1106, the transition is from the continuous locomotion motion space to a lead-in portion of the ending performed motion space; whereas, at step 1306, the transition is from the lead-out portion of the leading performed motion space to the continuous locomotion motion space.

FIG. 14 is a conceptual diagram illustrating transitioning from a leading performed motion space to a continuous locomotion motion space, according to one embodiment of the invention. As shown, a motion sequence begins at point 1402 and ends at point 1404. The motion sequence includes a leading performed motion 1406 and a continuous locomotion motion 1408. The leading performed motion 1406 includes a lead-out locomotion portion 1410 that follows a performed motion portion 1412.

As shown, the continuous locomotion motion 1408 and the lead-out locomotion portion 1410 of the leading performed motion 1406 overlap at portion 1414. The registration curve calculated for the transition shown in FIG. 14 would allow for a seamless transition from the leading performed motion 1406 to the continuous locomotion motion 1408, minimizing or possibly eliminating motion artifacts.

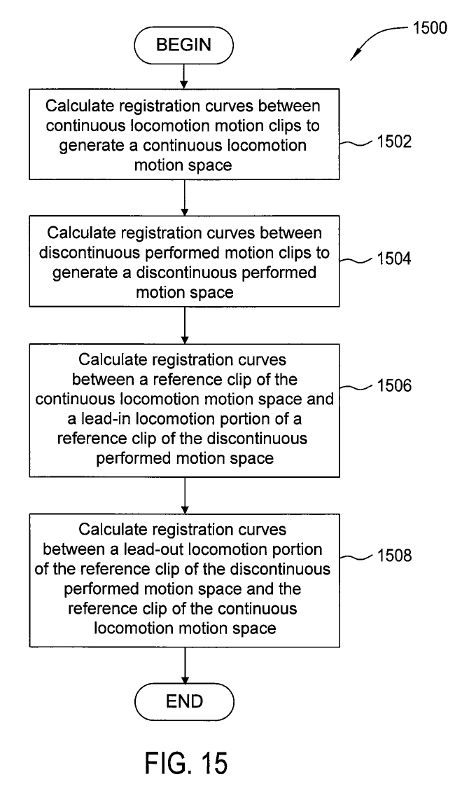

FIG. 15 is flow diagram of method steps for calculating an enveloping registration from a continuous locomotion motion class to a discontinuous and/or interrupted locomotion motion class and back to a continuous locomotion motion class, according to one embodiment of the invention. Persons skilled in the art will understand that even though method 1500 is described in conjunction with the systems of FIGS. 1-2 and 5-10, any system configured to perform the steps of the method 1500, in any order, is within the scope of the present invention. Further, persons skilled in the art will understand that the steps of the method 1500 are only one embodiment of the present invention.

As shown, the method 1500 beings at step 1502, where the rendering application calculates registration curves between continuous locomotion motion clips to generate a continuous locomotion motion space. In one embodiment, step 1502 is substantially similar to step 1102 in FIG. 11 and is not described in greater detail herein. In one embodiment, the continuous locomotion motion space is included in a continuous locomotion motion class.

At step 1504, the rendering application calculates registration curves between discontinuous and/or interrupted locomotion motion clips to generate a discontinuous and/or interrupted locomotion motion space. In one embodiment, step 1504 comprises the rendering application performing steps 302 and 304 described in FIG. 3, and is substantially similar to step 1102 in FIG. 11. In one embodiment, the discontinuous and/or interrupted locomotion motion space is included in a discontinuous locomotion motion class, an interrupted locomotion motion class, and/or a single motion class categorized by discontinuous and/or interrupted locomotion.

At step 1506, the rendering application calculates registration curves between a reference clip of the continuous locomotion motion space and a lead-in locomotion portion of a reference clip of the discontinuous and/or interrupted locomotion motion space. Step 1506 is substantially similar to step 1106, described in FIG. 11.

At step 1508, the rendering application calculates registration curves between a lead-out locomotion portion of a reference clip of the discontinuous and/or interrupted locomotion motion space and a reference clip of the continuous locomotion motion space. Step 1508 is substantially similar to step 1306, described in FIG. 13.

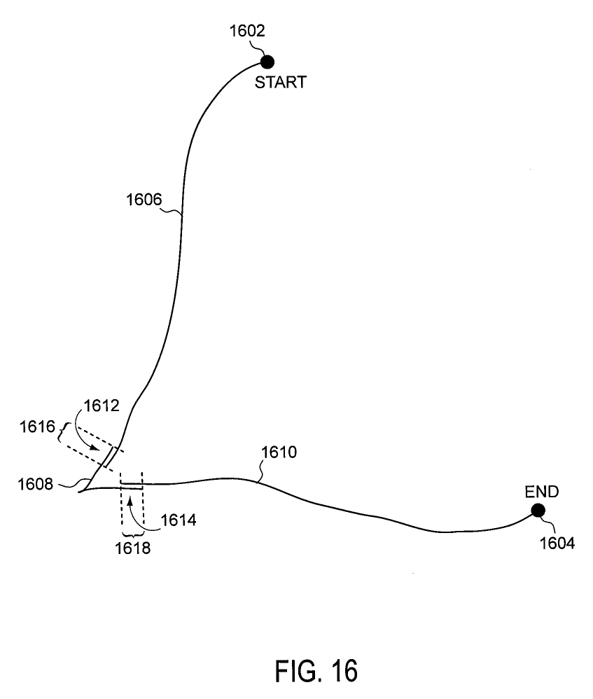

FIG. 16 is a conceptual diagram illustrating transitioning from a continuous locomotion motion space to a discontinuous locomotion motion space and back to a continuous locomotion motion space, according to one embodiment of the invention. As shown, a motion sequence begins at point 1602 and ends at point 1604. The motion sequence includes a first continuous locomotion motion 1606, a discontinuous motion 1608, and a second continuous locomotion motion 1610. The discontinuous motion 1608 includes a lead-in locomotion portion 1612 and a lead-out locomotion portion 1614.

As shown, the first continuous locomotion motion 1606 and the lead-in locomotion portion 1612 of the discontinuous locomotion motion 1608 overlap at portion 1616. Similarly, the second continuous locomotion motion 1610 and the lead-out locomotion portion 1614 of the discontinuous locomotion motion 1608 overlap at portion 1618. The enveloping registration shown in FIG. 16 allows for a seamless transition from a continuous locomotion motion to a discontinuous locomotion motion and back to a continuous locomotion motion, minimizing or possibly eliminating motion artifacts.

Although FIG. 16 shows an example of an enveloping registration involving a discontinuous locomotion motion space, the techniques described herein apply equally to an enveloping registration involving an interrupted locomotion motion space.

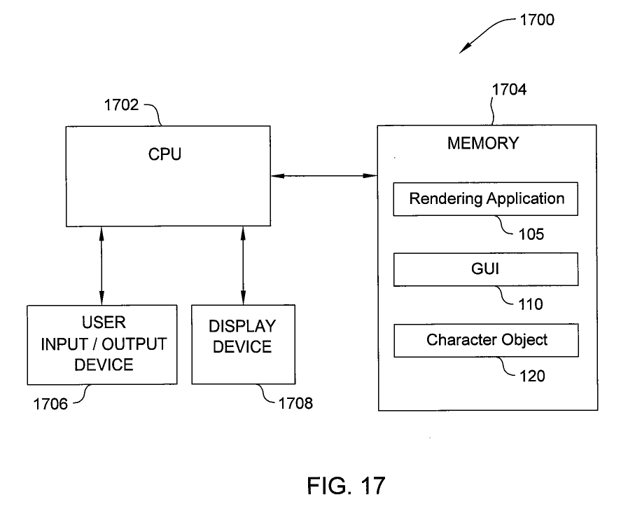

FIG. 17 is a block diagram of a computer system 1700 configured to implement one or more aspects of the present invention. As shown, the computer system 1700 includes a processor element 1702, such as a CPU or a graphics processing unit (GPU), a memory 1704, e.g., random access memory (RAM) and/or read only memory (ROM), various input/output devices 1706, which may include user input devices such as a keyboard, a keypad, a mouse, and the like, and storage devices, including but not limited to, a tape drive, a floppy drive, a hard disk drive or a compact disk drive, and a receiver, and various display devices 1708, which may include a cathode-ray tube (CRT) monitor or an liquid-crystal display (LCD) monitor. As also shown, the rendering engine 105, the GUI 110, and the character object 120 are stored within memory 1704. In some embodiments, the GUI 110 and or the character object 120 may be included within the rendering application 105. In some embodiments, the rendering engine 105 and/or the GUI 110 may include instructions executed by the processor element 1702.

In sum, the systems and methods described herein provide a real-time solution to the problem of aligning motions of a motion sequence. Since each motion clip available to the rendering application is categorized into one of six motion classes, substantially seamless transitions between various motion types may be made by performing a registration operation that is based on the initial motion class (i.e., before the transition) and the subsequent motion class (i.e., after the transition). As described herein, in one embodiment, a user may create custom motions using the rendering application. In alternative embodiments, the rendering application may automatically create a motion sequence for a character by transitioning between motion classes. For example, NPCs in a game may utilize the systems and methods described herein. Additionally, in another example, the rendering application may include a simulation component that automatically simulates characters moving about a scene (e.g., a virtual office building with characters that move around the office without any user control).

One advantage of the systems and method described herein is that they provide techniques for creating motion sequences having multiple motion types while minimizing or even eliminating motion artifacts at the transition points. Another advantage is that the framework provides an intuitive way for a user to create custom motion sequences by restricting the number of possible motion classes to which the motion sequence may transition based on the current motion class of the motion sequence.

While the forgoing is directed to embodiments of the present invention, other and further embodiments of the invention may be devised without departing from the basic scope thereof. For example, aspects of the present invention may be implemented in hardware or software or in a combination of hardware and software. In addition, one embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention. Therefore, the scope of the present invention is determined by the claims that follow.

What is claimed is:

1. A method for generating a motion sequence of a character object in a rendering application executing on a computer system, the method comprising:
selecting a first motion clip associated with a first motion class, wherein the first motion clip is stored in a memory included within the computer system;
selecting a second motion clip associated with a second motion class, wherein the second motion clip is stored in the memory included within the computer system;
generating a registration curve that temporally and spatially aligns one or more frames of the first motion clip with one or more frames of the second motion clip; and
rendering the motion sequence of the character object by blending the one or more frames of the first motion clip with one or more frames of second motion clip based on the registration curve.

2. The method of claim 1, wherein the first motion clip is blended from two or more motion clips associated with the first motion class.

3. The method of claim 2, wherein the first motion clip allows for steering the character object towards a goal location.

4. The method of claim 1, wherein the first motion clip is unblended.

5. The method of claim 1, wherein the second motion clip is blended from two or more motion clips associated with the second motion class.

6. The method of claim 5, wherein the second motion clip allows for steering the character object towards a goal location.

7. The method of claim 1, wherein the second motion clip is unblended.

8. The method of claim 1, wherein a plurality of motion clips is stored in the memory, and wherein each motion clip in the plurality of motion clips is associated with one of six different motion classes that include the first motion class and the second motion class.

9. The method of claim 8, wherein each of the six different motion classes is defined by a different motion type, and wherein a registration type between two motion classes defines how the two motion classes are operationally combined with one another.

10. The method of claim 8, wherein the six different motion classes comprise a continuous locomotion motion space class, an ending performed motion space class, a stationary performed motion space class, a leading performed motion space class, a discontinuous locomotion motion space class, and an interrupted locomotion motion space class.

11. The method of claim 10, wherein the first motion class comprises the continuous locomotion motion space class and the second motion class comprises the ending performed motion space class, and wherein the registration curve comprises an ending registration that temporally and spatially aligns the one or more frames of the first motion clip with one or more frames associated with a lead-in locomotion portion of the second motion clip.

12. The method of claim 10, wherein the first motion class comprises the leading performed motion space class and the second motion class comprises the continuous locomotion motion space class, and wherein the registration curve comprises a leading registration that temporally and spatially aligns one or more frames associated with a lead-out locomotion portion of the first motion clip with the one or more frames of the second motion clip.

13. The method of claim 1, further comprising the steps of:
selecting a third motion clip associated with the first motion class, wherein the third motion clip is stored in the memory included within the computer system; and
generating a second registration curve that temporally and spatially aligns one or more frames of the second motion clip with one or more frames of the third motion clip.

14. The method of claim 13, wherein the first motion class comprises a continuous locomotion motion space class and the second motion class comprises a discontinuous locomotion motion space class or an interrupted locomotion motion space class, and wherein the registration curve comprises a first portion of an enveloping registration that temporally and spatially aligns the one or more frames of the first motion clip with one or more frames associated with a lead-in locomotion portion of the second motion clip, and the second registration curve comprises a second portion of the enveloping registration that temporally and spatially aligns one or more frames associated with a lead-out locomotion portion of the second motion clip with the one or more frames of the third motion clip.

15. A computer-readable storage medium storing instructions that, when executed by a processor, cause the processor to generate a motion sequence of a character object, by performing the steps of:
selecting a first motion clip associated with a first motion class, wherein the first motion clip is stored in a memory;
selecting a second motion clip associated with a second motion class, wherein the second motion clip is stored in the memory;
generating a registration curve that temporally and spatially aligns one or more frames of the first motion clip with one or more frames of the second motion clip; and
rendering the motion sequence of the character object by blending the one or more frames of the first motion clip with one or more frames of second motion clip based on the registration curve.

16. The computer-readable storage medium of claim 15, wherein the first motion clip is blended from two or more motion clips associated with the first motion class and/or the second motion clip is blended from two or more motion clips associated with the second motion class.

17. The computer-readable storage medium of claim 15, wherein a plurality of motion clips is stored in the memory, and wherein each motion clip in the plurality of motion clips is associated with one of six different motion classes that include the first motion class and the second motion class.

18. The computer-readable storage medium of claim 17, wherein the six different motion classes comprise a continuous locomotion motion space class, an ending performed motion space class, a stationary performed motion space class, a leading performed motion space class, a discontinuous locomotion motion space class, and an interrupted locomotion motion space class.

19. The computer-readable storage medium of claim 18, wherein the first motion class comprises the continuous locomotion motion space class and the second motion class comprises the ending performed motion space class, and wherein the registration curve comprises an ending registration that temporally and spatially aligns the one or more frames of the first motion clip with one or more frames associated with a lead-in locomotion portion of the second motion clip.

20. A computer system for generating a motion sequence of a character, comprising:
a processor; and
a memory storing instructions that, when executed by the processor, cause the computer system to:
select a first motion clip associated with a first motion class, wherein the first motion clip is stored in a memory included within the computer system;
select a second motion clip associated with a second motion class, wherein the second motion clip is stored in the memory included within the computer system;
generate a registration curve that temporally and spatially aligns one or more frames of the first motion clip with one or more frames of the second motion clip; and
render the motion sequence of the character object by blending the one or more frames of the first motion clip with one or more frames of second motion clip based on the registration curve.
